(19) United States
(12) Patent Application Publication
(10) Pub. No.: US 2005/0017946 A1
(43) Pub. Date: Jan. 27, 2005

(54) Portable wireless display device capable of setting operation modes and operation method therefor

(75) Inventor: Jin-youl Park, Suwon-City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD

(21) Appl. No.: 10/891,523

(22) Filed: Jul. 15, 2004

Related U.S. Application Data
(63) Continuation of application No. 10/787,390, filed on Feb. 27, 2004.

(30) Foreign Application Priority Data
Jul. 22, 2003 (KR) 2003-50253

(51) Int. Cl. G09G 5/00

(52) U.S. Cl. 345/156

(57) ABSTRACT

A portable wireless display device, comprising an input unit, a control unit and a storage unit. The input unit is adapted to input a setting command to set an operation mode of the portable wireless display device to be in a docking state with a docking station. The control unit is adapted to set the operation mode corresponding to the setting command. The storage unit is adapted to store the set operation mode.

### CROSS-REFERENCE TO RELATED APPLICATION

This application claims the benefit of Korean Patent Application No. 2003-50253, dated Jul. 22, 2003, in the Korean Intellectual Property Office, the disclosure of which is incorporated herein by reference.

### BACKGROUND

1. Field

This disclosure relates to a portable wireless display device, and more particularly, to a portable wireless display device capable of setting operation modes.

2. Description of the Related Technology

Personal computers are used to perform various kinds of information processing tasks such as surfing the web, using emails, listening to music, watching videos, etc. A portable display device capable of performing wireless communications, so called “Smart display” has been developed to aid in this information processing.

FIG. 1 shows an example of an information processing system with a portable wireless display device. The information processing system has a host 110, a portable display device 130, and a docking station 150 for docking the host 110 with the display device 130.

The portable wireless display device 130 as above requires two types of platforms depending upon the docking structures thereof.

When the wireless display device 130 is undocked from the host 110, it acts as a display device capable of performing wireless communications. In such a state, users perform tasks such as surfing the web, using emails, listening to music, etc. For convenience, in such a state the portable display device can be used in any place, for example, on sofas in the living room, kitchen counter, dining table, outdoor, etc. In other words, in the undocked state, the portable wireless display device 130 executes a process for enabling wireless communications with the host 110.

On the other hand, if the portable wireless display device 130 is docked in the docking station 150 to connect to the host 110, the portable wireless display device 130 performs only a display function.

The conventional portable wireless display device 130 establishes an operation mode based on the state of the docking structure. That is, the portable wireless display device 130 has a monitor mode for carrying out a display function when in a docking state, and a wireless monitor mode for carrying out a wireless communication-enabled display function when in an undocked state. For example, even when a user intends to merely charge batteries of the portable wireless display device 130 in the wireless monitor mode, it is forced to be switched to the monitor mode and docked to the docking station regardless of the user's intent. It becomes inconvenient, then to dismount the portable wireless display device 130 in order to switch the device 130 to the wireless monitor mode and execute a process for connecting the device 130 to the host 110 again.

### SUMMARY

To overcome some of the disadvantages noted above, there is provided a portable wireless display device capable of setting operation modes and an operation mode setting/operation method therefor.

An aspect of the disclosed teachings is a portable wireless display device, comprising an input unit, a control unit and a storage unit. The input unit is adapted to input a setting command to set an operation mode of the portable wireless display device to be in a docking state with a docking station. The control unit is adapted to set the operation mode corresponding to the setting command. The storage unit is adapted to store the set operation mode.

In a specific enhancement, the operation mode includes a monitor mode adapted to perform wired communications with a host, and a wireless monitor mode adapted to perform wireless communications with the host.

In another specific enhancement, the portable wireless display device further comprises a display unit adapted to display an operation mode setting window to set the operation mode, wherein the control unit uses a program stored in the storage unit to display the operation mode setting window.

Preferably, the input unit is at least one of an operation panel having plural keys, a keyboard, a mouse, and a touch panel.

Another aspect of the disclosed teachings is an information processing system with a host, a docking station and a wireless portable display device as described above.

Another aspect of the disclosed teachings is an operation mode setting method for a portable wireless display device comprising inputting a setting command for setting an operation mode of the portable wireless display device in a state that the portable wireless display device docks with the docking station. The operation mode is set corresponding to the setting command and the set operation mode is stored

In a specific enhancement, the operation mode includes a monitor mode for performing wired communications with a host, and a wireless monitor mode for performing wireless communications with the host.

In another specific enhancement, the method further comprises externally displaying an operation mode setting window to set the operation mode, wherein the input step inputs the setting command based on the operation mode setting window.

More specifically, the operation mode setting window is an On-Screen Display (OSD).

In another specific enhancement, the input step inputs the setting command using at least one of an operation panel having plural keys, a keyboard, a mouse, and a touch panel.

Yet another aspect of the disclosed teachings is an operation method for a portable wireless display device comprising setting an operation mode of the portable wireless display device in a state that the portable wireless display device docks with a docking station. The set operation mode is controlled. The operations of the portable wireless display device are controlled in correspondence with the set operation mode.

In a specific enhancement, the operation mode in the setting step includes a monitor mode for performing wired communications with a host, and a wireless monitor mode for performing wireless communications with the host.

In another specific enhancement, if the monitor mode is set in the setting step the control step controls the portable wireless display device to perform wired communications with the host.

In another specific enhancement, if the wireless monitor mode is set in the setting step the control step controls the portable wireless display device to perform wireless communications with the host.

In another specific enhancement, the operation mode in the setting step further includes a display mode for displaying a mode switchover display window.

More specifically, the method further comprises checking whether the portable wireless display device docks with the docking station if the display mode is set in the setting step; and displaying the mode switchover display window if the portable wireless display device docks with the docking station.

More specifically, the mode switchover display window is an On-Screen Display (OSD).

The operation mode in the setting step includes a monitor mode for performing wired communications with the host, and a wireless monitor mode for performing wireless communications with the host.

Preferably, if the monitor mode is set in the setting step, the control step controls the portable wireless display device to perform wired communications with the host, and, if the wireless monitor mode is set in the setting step, the control step controls the portable wireless display device to perform wireless communications with the host.

More preferably, the operation mode in the setting step further includes a display mode for displaying a mode switchover display window, and the operation method further comprises steps of, if the display mode is set in the setting step, checking whether the portable wireless display device docks with the docking station; and displaying the mode switchover display window if the portable wireless display device docks with the docking station.

Accordingly, the portable wireless display device is prevented from mode switchovers that are not necessary nor intended by a user since the user sets an operation mode of the portable wireless display device. Therefore, the present invention can prevent the portable wireless display device from unnecessarily connecting to a host regardless of user's intent.

### BRIEF DESCRIPTION OF THE DRAWINGS

The disclosed teachings will be described in detail with reference to the following drawings in which like reference numerals refer to like elements, and wherein:

FIG. 1 shows an example of a schematic structure of an information processing system having a conventional portable wireless display device;

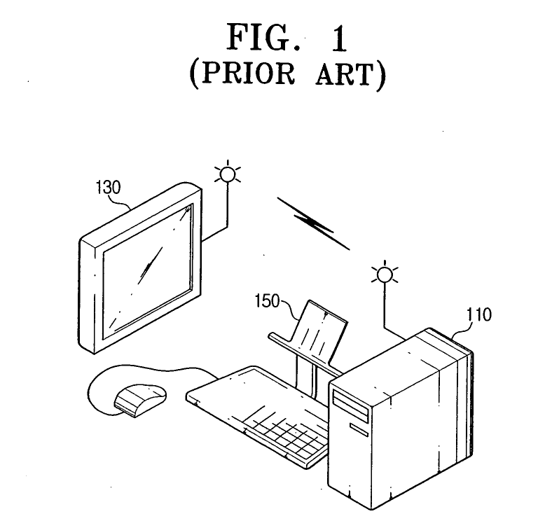

FIG. 2 shows a block diagram for an example of a portable wireless display device incorporating some of the disclosed teachings;

FIG. 3a shows an example of an operation mode setting window displayed on the portable wireless display device of FIG. 2;

FIG. 3b shows an example of a mode switchover display window out of an operation mode setting menu of the portable wireless display device of FIG. 2; and

FIG. 4a and FIG. 4b depict flow charts each showing an example operation process depending upon an operation mode set to the portable wireless display device of FIG. 2.

### DETAILED DESCRIPTION

Hereinafter, disclosed teachings are described in detail with reference to the accompanying drawings.

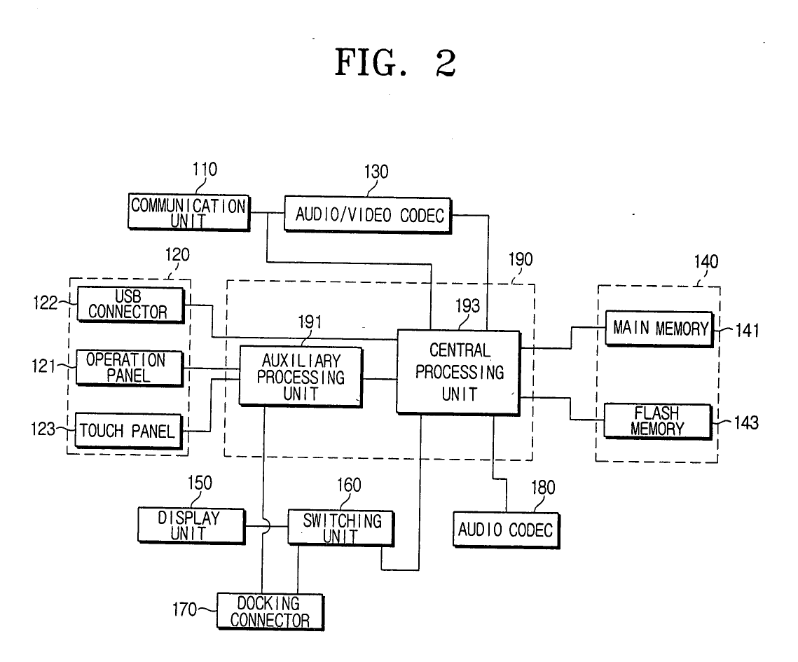

FIG. 2 shows a block diagram for an example of a portable wireless display device incorporating some of the disclosed teachings.

The portable wireless display device has a communication unit 110, an input unit 120, an audio/video codec 130, a storage unit 140, a display unit 150, a switching unit 160, a docking connector 170, an audio codec 180, a control unit 190, and so on.

The communication unit 110 is a wireless module, such as a wireless LAN card, in which a protocol such as Remote Desktop Protocol (RDP) of the lowest hardware level is built to support wireless communications.

The input unit 120 has an operation panel 121, a USB connector 122, a touch panel 123, etc.

The operation panel 121 is a panel provided with keys for manipulating the portable wireless display device. These keys include keys for manipulating electric power, volume, brightness, and the like, navigation keys, shortcut keys, etc. In addition, a key for operation mode setting, which will be later described, is included.

The USB connector 122 is connected to an input device such as an USB keyboard, a mouse, and the like. In case that the portable wireless display device is dismounted, a user can input data through the keyboard and the mouse connected to the USB connector 122.

The touch panel 123 processes a signal in accordance with the result touching the touch panel. The touch panel 123 is used as a user interface for application programs like a web browser.

The audio/video codec 130 decodes audio/video data encoded in a predetermined format which is received through the communication unit 110. Such an operation is controlled by the central processing unit 193.

The storage unit 140 has a main memory 141 and a flash memory 143.

The main memory 141 stores commands, data, etc, that the central processing unit 193 can instantly use. The main memory 141 generally stores important parts of the operating system, a part or all of the application program, data that is used currently, etc. In addition, the main memory stores an application program establishing operation modes, which will be later described.

The flash memory 143 stores various application programs related to the function of a central processing unit 193, and also stores an application program for performing an operation mode setting.

The display unit 150 displays signal-processed video data externally, for which a portable TFT-LCD is generally used.

The switching unit 160 selectively switches the video data displayed on the display unit 150. This operation is controlled by the central processing unit 193. The video data output to the display unit 150 has two paths through which video data is input. In a docked state, a path is used for outputting video data input from the docking connector 17. In the undocked state, another path is used for outputting video data received from the communication unit 110. Accordingly, the switching unit 160 selects a video data path based on the controls received from the central processing unit 193 for an output depending upon the docking state.

The docking connector 170 provides an auxiliary processing unit 191 with state information depending upon whether the portable wireless display device is in a docked state or undocked state with the docking station (not shown). At this time, the auxiliary processing unit 191 checks the docking state, and provides the central processing unit 193 with information regarding the docking state. The central processing unit 193 processes the overall operations of the portable wireless display device according to the docking state.

The audio codec 180 processes audio data based on controls provided by the central processing unit 193. That is, the audio codec 180 outputs the processed audio signal to an audio output unit(not shown) such as speakers, headphones, and the like. In addition it processes an audio signal inputted from an audio input unit(not shown) such as microphones and the like.

The control unit 190 includes the auxiliary processing unit 191 and the central processing unit 193.

The auxiliary processing unit 191 may be a general co-processor. It is a processing unit assisting the central processing unit 193. For example, the auxiliary processing unit 191 assists the processing of the central processing unit 193 with respect to the data input and output through the operation panel 121, touch panel 123, docking connector 170, etc. The central processing unit 193 processes and controls the overall operations of the portable wireless display unit.

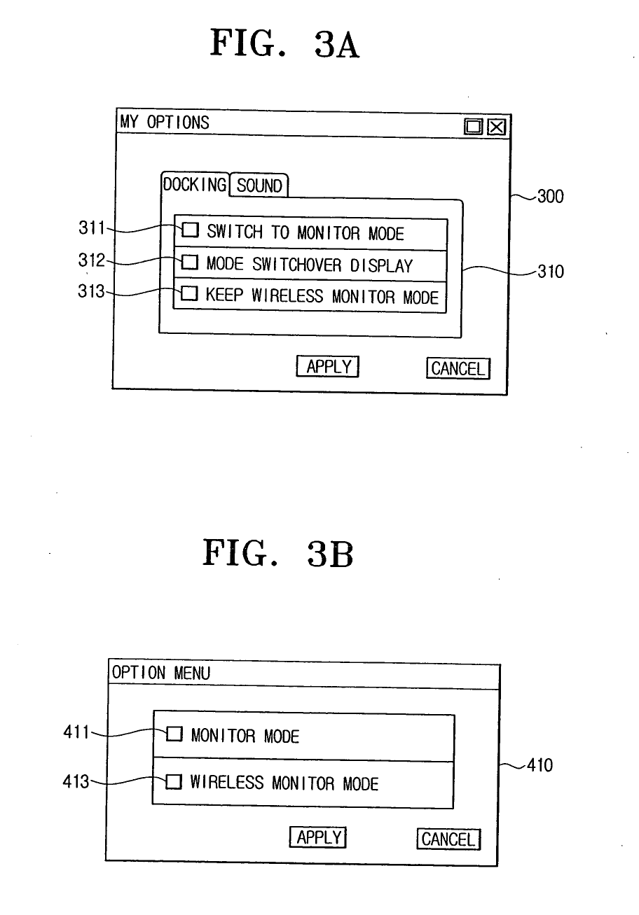

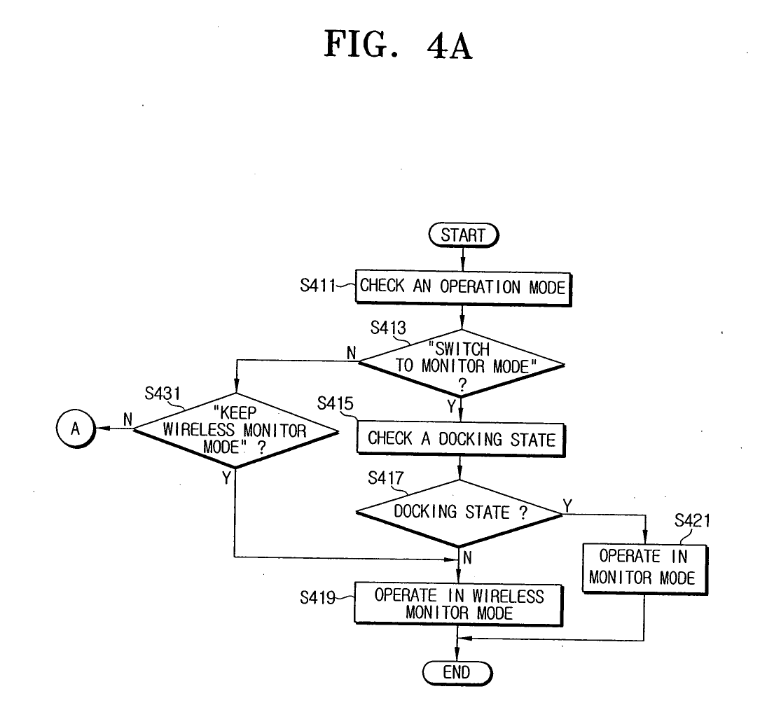

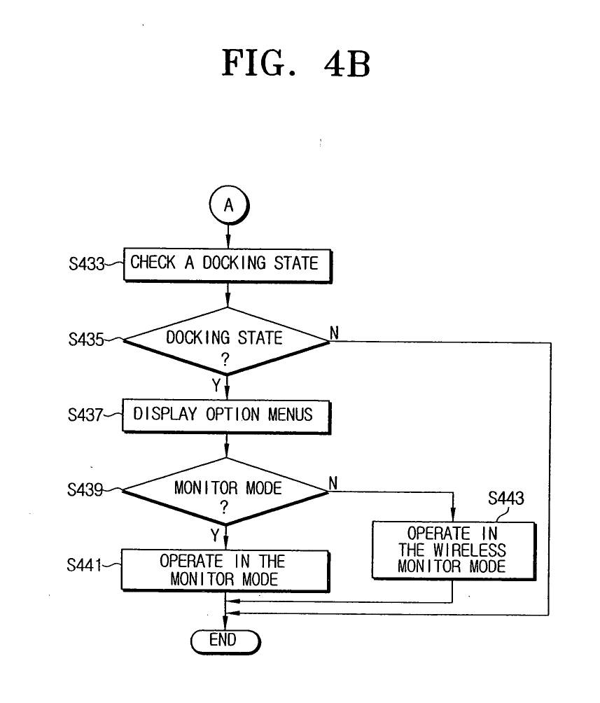

Hereinafter, descriptions will be made on the operation mode setting for the portable wireless display device and the operation process in a set operation mode according to the present invention with reference to FIG. 3 and FIG. 4.

The operation mode setting is performed, for example, through the “control panel-type setting” implemented in software. Alternately, it could be performed using an “operation mode setting key” implemented in hardware, etc.

First, the “control panel-type setting” implemented in software is described as follows. A setting command for environment settings is input through a keyboard or a mouse connected to the touch panel 123 and/or the USB connector 122 which is provided on the input unit 120, the central processing unit 193 runs an application program for environment settings out of diverse application programs stored in the flash memory 143, and displays an image for the environment setting on the display unit 150.

In other words, as shown in FIG. 3a, the central processing unit 193 displays an environment setting window 300, and activates the operation mode setting window 310. The operation mode setting window 310 displays option menus for operation modes when the portable wireless display device is in the docking state.

For example, the option menus for the operation modes in the docking state include a “switch to monitor mode” 311 for setting the portable wireless display device to a monitor simply performing wired communications with the host, a “keep wireless monitor mode” 313 for setting the portable wireless display device to a wireless monitor performing wireless communications with the host without mode switchovers, and a “mode switchover display” 312 for displaying a mode switchover window, and so on.

That is, if the operation mode is set to the “switch to monitor mode”, the central processing unit 193 sets the operation mode of the portable wireless display device to the monitor mode in case that the portable wireless display device docks with the docking station(not shown), and, if the operation mode is set to the “keep wireless monitor mode” 313, the central processing unit 193 keeps the operation mode of the portable wireless display device in the wireless monitor mode in order for the portable wireless display device to operate in the wireless monitor mode even in case that the portable wireless display device docks with the docking station(not shown).

Further, if the operation mode is set to the “mode switchover display” 312, the central processing unit 193 displays a menu window 410 on which a user can select an operation mode in the on-screen display (OSD), as shown in FIG. 3b, if the portable wireless display device docks with the docking station(not shown). Accordingly, the user sets the operation mode of the portable wireless display device to either a “monitor mode” 411 or a “wireless monitor mode” 413 according to the user's current situation.

In the meantime, shortcut keys are provided in hardware on the operation panel 121 to correspond to the monitor mode and the wireless monitor mode. For example, using the shortcut keys such as a monitor mode key, a wireless mode key, and so on, a user sets the operation mode of the portable wireless display device through the shortcut keys in the docking state of the portable wireless display device. However, the shortcut keys may be separately provided as above, or only such functions may be set to existing keys.

Further, the above descriptions have been made on an instance in which a certain application program is used to display the operation mode setting window, such as reference numeral 300 of FIG. 3a, for operation mode settings, but the operation mode can obviously set through a setting window in use of the on-screen display (OSD).

FIG. 4a and FIG. 4b are flow charts each showing an operation process according to an operation mode set to the portable wireless display device.

As aforementioned, if an operation mode is set through the input unit 120 in a software or a hardware fashion upon docking the portable wireless display device, the central processing unit 193 stores information on the set operation mode into the main memory 141, and controls the operations of the portable wireless display device in correspondence with the set operation mode. The operation process for the portable wireless display device is as follows.

The central processing unit 193 checks a set operation mode stored in the main memory 141(S411).

First, in case that the set operation mode is the “switch to monitor mode”, the central processing unit 193 checks a current docking state based on docking state information transferred from the auxiliary processing unit 191(S415). The auxiliary processing unit 191 provides the central processing unit 193 with the docking state information based on an electric signal sent from the docking connector 170.

If the portable wireless display device is mounted in the docking station(not shown), the docking connector 170 sends an electric signal such as logic voltage “high” to the auxiliary processing unit 191. Further, if the portable wireless display device is not mounted in the docking station(not shown), the docking connector 170 sends an electric signal such as logic voltage “low” to the auxiliary processing unit 191. As such, the auxiliary processing unit 191 decides whether the portable wireless display device docks or undocks based on the electric signal provided depending upon the docking state of the docking connector 170 of the portable wireless display device with the docking station(not shown), and provides the central processing unit 193 with the corresponding docking state information.

The central processing unit 193 checks the docking state based on the docking state information provided from the auxiliary processing unit 191. As a result of the check, if the portable wireless display device docks with the docking station(not shown), the central processing unit 193 controls the portable wireless display device to perform only the monitor function (S421).

If the portable wireless display device undocks with the docking station (not shown) as a result of the docking state check (S417), the central processing unit 193 controls the portable wireless display device to operate in the wireless monitor mode (S419).

Next, if the set operation mode is the “keep wireless monitor mode” (S431), the central processing unit 193 operates the portable wireless display device in the wireless monitor mode regardless of the docking state information sent from the auxiliary processing unit 191 (S419). That is, even when the portable wireless display device is mounted in the docking station (not shown), the portable wireless display device operates in the wireless monitor mode if the operation mode is set to the “keep wireless monitor mode”.

In the meantime, if the set operation mode is the “mode switchover display”, the central processing unit 193 checks the docking state based on the docking state information provided from the auxiliary processing unit 191 (S433). If the portable wireless display device docks with the docking station(not shown) as a result of the check (S435), the central processing unit 193 produces in the OSD and displays an option menu window 410 on the display unit 150 as shown in FIG. 3b (S437). In here, the option menu window 410 has option menus such as “monitor mode” 411, “wireless monitor mode” 413, and so on.

The central processing unit 193 operates the portable wireless display device in correspondence with an operation mode that a user selects. For example, if the user selects the “monitor mode” 411 (S439), the portable wireless display device mounted in the docking station operates in the monitor mode (S441), and, if the user selects the “wireless monitor mode”, the portable wireless display device mounted in the docking station operates in the wireless monitor mode (S443).

Accordingly, the present invention can solve the problem of the conventional portable wireless display device having a uniformed operation mode depending upon the docking structure.

The present invention enables a user to set an operation mode of the portable wireless display device so as to prevent mode switchovers which are unnecessary or not intended by the user. Accordingly, the present invention can prevent the portable wireless display device from unnecessarily connecting to a host regardless user's intent.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

1. A portable wireless display device, comprising:
an input unit that is adapted to input a setting command to set an operation mode of the portable wireless display device to be in a docking state with a docking station;
a control unit adapted to set the operation mode corresponding to the setting command; and
a storage unit for storing the set operation mode.

2. The portable wireless display device of claim 1, wherein the operation mode includes:
a monitor mode adapted to perform wired communications with a host, and
a wireless monitor mode adapted to perform wireless communications with the host.

3. The portable wireless display device of claim 1, further comprising:
a display unit adapted to display an operation mode setting window to set the operation mode, wherein the control unit uses a program stored in the storage unit to display the operation mode setting window.

4. The portable wireless display device of claim 3, wherein the operation mode setting window is an On-Screen Display (OSD).

5. The portable wireless display device of claim 1, wherein the input unit is at least one of an operation panel having plural keys, a keyboard, a mouse, and a touch panel.

6. An information processing system comprising:
a host computer;
a docking station;
a portable wireless display device,
the portable wireless display device further including:
an input unit that is adapted to input a setting command to set an operation mode of the portable wireless display device to be in a docking state with the docking station;
a control unit adapted to set the operation mode corresponding to the setting command; and
a storage unit for storing the set operation mode.

7. The information processing system of claim 6, wherein the operation mode includes:
a monitor mode adapted to perform wired communications with a host, and
a wireless monitor mode adapted to perform wireless communications with the host.

8. The information processing system of claim 6, further comprising:
a display unit adapted to display an operation mode setting window to set the operation mode, wherein the control unit uses a program stored in the storage unit to display the operation mode setting window.

9. The information processing system of claim 8, wherein the operation mode setting window is an On-Screen Display (OSD).

10. The information processing system of claim 6, wherein the input unit is at least one of an operation panel having plural keys, a keyboard, a mouse, and a touch panel.

11. An operation mode setting method for a portable wireless display device comprising:
inputting a setting command for setting an operation mode of the portable wireless display device in a state that the portable wireless display device docks with the docking station;
setting the operation mode corresponding to the setting command; and
storing the set operation mode.

12. The operation mode setting method of claim 11, wherein the operation mode includes a monitor mode for performing wired communications with a host, and a wireless monitor mode for performing wireless communications with the host.

13. The operation mode setting method of claim 11, further comprising:
externally displaying an operation mode setting window to set the operation mode, wherein the input step inputs the setting command based on the operation mode setting window.

14. The operation mode setting method of claim 13, wherein the operation mode setting window is an On-Screen Display (OSD).

15. The operation mode setting method of claim 11, wherein the input step inputs the setting command using at least one of an operation panel having plural keys, a keyboard, a mouse, and a touch panel.

16. An operation method for a portable wireless display device comprising:
setting an operation mode of the portable wireless display device in a state that the portable wireless display device docks with a docking station;
storing the set operation mode; and
controlling the operations of the portable wireless display device in correspondence with the set operation mode.

17. The operation method of claim 16, wherein the operation mode in the setting step includes a monitor mode for performing wired communications with a host, and a wireless monitor mode for performing wireless communications with the host.

18. The operation method of claim 16, wherein, if the monitor mode is set in the setting step, the control step controls the portable wireless display device to perform wired communications with the host.

19. The operation method of claim 16, wherein, if the wireless monitor mode is set in the setting step, the control step controls the portable wireless display device to perform wireless communications with the host.

20. The operation method of claim 16, wherein the operation mode in the setting step further includes a display mode for displaying a mode switchover display window.

21. The operation method of claim 20, further comprising:
checking whether the portable wireless display device docks with the docking station if the display mode is set in the setting step; and
displaying the mode switchover display window if the portable wireless display device docks with the docking station.

22. The operation method as claimed in claim 20, wherein the mode switchover display window is an On-Screen Display (OSD).
